(19) United States
(12) Patent Application Publication
(10) Pub. No.: US 2013/0235030 A1
(43) Pub. Date: Sep. 12, 2013

(54) IMAGE PROCESSING DEVICE, IMAGE PROCESSING METHOD AND NON-TRANSITORY COMPUTER READABLE RECORDING MEDIUM FOR RECORDING IMAGE PROCESSING PROGRAM

(71) Applicant: KABUSHIKI KAISHA TOSHIBA, Tokyo (JP)

(72) Inventor: Tatsuro FUJISAWA, Tokyo (JP)

(73) Assignee: Kabushiki Kaisha Toshiba, Tokyo (JP)

(21) Appl. No.: 13/682,202

(22) Filed: Nov. 20, 2012

(30) Foreign Application Priority Data
Mar. 9, 2012 (JP) 2012-52833

(51) Int. Cl. G06T 15/00

(52) U.S. Cl. CPC G06T 15/00
USPC 345/419

(57) ABSTRACT

According to one embodiment, an image processing device includes a block determiner, a flat area generator, and a depth information generator. The block determiner is configured to determine whether each block in an input image is a flat block or a non-flat block. The flat area generator is configured to generate a flat area having at least one flat block based on continuity of the flat block. The depth information generator is configured to generate depth information added to each flat block in the flat area.

### CROSS REFERENCE TO RELATED APPLICATIONS

This application is based upon and claims the benefit of priority from the prior Japanese Patent Application No. 2012-52833, filed on Mar. 9, 2012, the entire contents of which are incorporated herein by reference.

### FIELD

Embodiments described herein relate generally to an image processing device, an image processing method and a non-transitory computer readable recording medium for recording image processing.

### BACKGROUND

Recently, stereoscopic displays which display an image stereoscopically have been widely used. In this kind of stereoscopic displays, a plurality of parallax images viewed from different viewpoints are displayed on the display, and the image is stereoscopically seen by viewing one of the parallax images with left eye and another of the parallax images with right eye. With regard to autostereoscopic display manner which does not use glasses, it is preferable to display not only two parallax images for left eye and right eye, but also more parallax images.

In order to do so, it is necessary to calculate a depth value for each pixel from the parallax images for left eye and the one for right eye, and to generate more parallax images based on the calculated depth value.

For calculating the depth value, for example, the depth value can be calculated based on a shift amount between one block in the parallax image for left eye and the corresponding block in the one for right eye obtained by performing stereo-matching between the parallax image for left eye and the one for right eye. However, in a flat area, it is difficult to detect the corresponding area accurately because features between the parallax images are similar. As a result, incorrect depth values may be obtained in the flat area.

### BRIEF DESCRIPTION OF THE DRAWINGS

FIG. 1 is a schematic block diagram showing an image processing device according to one embodiment.

FIG. 2 is a flowchart showing an example of processing operation of the image processing device of FIG. 1.

FIGS. 3A and 3B are diagrams showing an example of the flat block determination.

FIGS. 4A to 4C are diagrams showing an example of the labeling processing, which explains Step S3 of FIG. 2.

FIG. 5 is a flowchart showing procedures of the labeling processing.

FIGS. 6A and 6B are diagrams showing an example of the elimination processing.

FIGS. 7A and 7B are diagrams showing an example of the combining processing.

FIG. 8 is a diagram showing an example of depth information generation.

FIGS. 9A and 9B are diagrams showing another example of depth information generation.

FIGS. 10A to 10C are diagrams showing the generated depth information schematically.

FIG. 11 is a diagram showing a shift direction on the display 10 for objects displayed at near-side.

FIG. 12 is a diagram showing a shift direction on the display 10 for objects displayed at further-side.

FIG. 13 is a diagram showing another example of depth information generation.

### DETAILED DESCRIPTION

In general, according to one embodiment, an image processing device includes a block determiner, a flat area generator, and a depth information generator. The block determiner is configured to determine whether each block in an input image is a flat block or a non-flat block. The flat area generator is configured to generate a flat area having at least one flat block based on continuity of the flat block. The depth information generator is configured to generate depth information added to each flat block in the flat area.

Embodiments will now be explained with reference to the accompanying drawings.

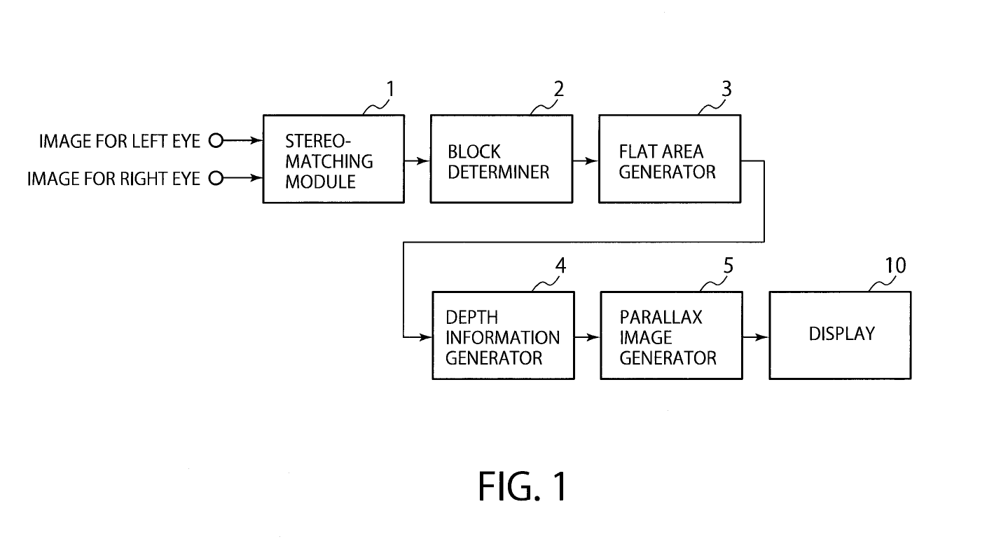

FIG. 1 is a schematic block diagram showing an image processing device according to one embodiment. The image processing device has a stereo-matching module 1, a block determiner 2, a flat area generator 3, a depth information generator 4, a parallax image generator 5 and a display 10. Among them, components except the display 10 are implemented as an IC (Integrated Circuit).

The present image processing device generates a plurality of (for example, nine) parallax images from an image for left eye and an image for right eye, and stereoscopically displays an image in the autostereoscopic manner. The image for left eye is an image from a first viewpoint, and the image for right eye is an image from a second viewpoint which is at right side of the first viewpoint. The images for left eye and right eye are divided into block composed of a plurality of pixels when processed by the image processing device. Although the size of the block is arbitrary, the block is composed by 8×8 pixels, for example.

The images for left eye and right eye may be obtained by receiving and tuning the broadcast wave, or by being read out from a recording medium such as optical disc or hard disk.

The stereo-matching module 1 performs stereo-matching on the images for left eye and right eye, and adds tentative depth information to the image for left eye or the image for right eye. The depth information is, for example, a depth value indicating how far the block should be seen at near-side or far-side from the display 10. Hereinafter, it is assumed that the tentative depth information is added to each block in the image for left eye, and that the image for left eye and the tentative depth information are outputted.

The block determiner 2 determines whether each block in the image for left eye is a flat or non-flat. Hereinafter, the block determined to be flat is named “flat block” and the one determined to be non-flat is named “non-flat block”.

The flat area generator 3 adds a label into each flat block by performing labeling processing on the flat blocks taking continuity of the flat blocks into consideration. A flat area is formed by flat blocks to which common label is added. That is, the number of generated flat area is equal to the number of labels, and each flat area includes one or a plurality of flat blocks. Furthermore, the flat area generator 3 may perform elimination processing for eliminate a flat area including a few flat blocks, and/or perform combining processing for combining a plurality of non-continuous flat areas having similar features, if needed.

The depth information generator 4 generates depth information added to all of the flat blocks in each of the flat areas in common using, for example, the tentative depth information of the flat block in the flat area or the depth information of the non-flat block around the flat block in the flat area.

The parallax image generator 5 generates nine parallax images based on the image for left eye and the depth information. The depth information means the depth information generated by the depth information generator 4 for each block in the flat area, and means the tentative depth information added by the stereo-matching module 1 for the other blocks.

The display 10 displays the plurality of parallax images simultaneously. Then, a lenticular lens (not shown) is attached on the display 10, and the output direction of each of the parallax images is controlled. By viewing one of the nine parallax images with left eye and another of the nine parallax images with right eye, the image is stereoscopically viewed. Of course, it is possible to realize stereoscopic viewing by another manner such as using parallax barrier and so on.

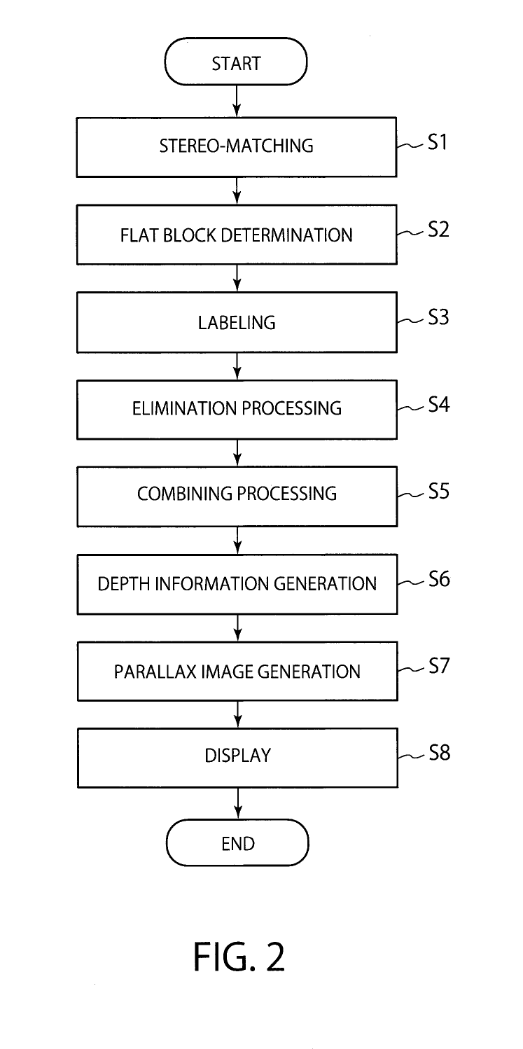

FIG. 2 is a flowchart showing an example of processing operation of the image processing device of FIG. 1. With reference to FIG. 2, processing operation of each component will be explained in detail.

Firstly, the stereo-matching module 1 performs stereo-matching on the images for left eye and right eye, to add the tentative depth information to each block in the image for left eye (Step S1). In the stereo-matching processing, with regard to one block in the image for left eye, a corresponding block in the image for right eye is searched, the corresponding block being a block in the image for right eye which minimizes the error (for example, a sum of absolute difference of each pixel) from the block in the image for left eye. Then, the stereo-matching module 1 calculates the tentative depth information of each block based on how much both blocks are shifted, that is, a parallax.

By the stereo-matching, rather accurate depth information is generated in a part of edges of objects and so on. On the other hand, accurate depth information is not always generated in a flat part such as a wall with only white color and sky with only blue color. This is because the error between the image for left eye and the one for right eye is small in the flat part, and thus, incorrect search processing may be performed. Therefore, the depth information added by the stereo-matching processing is called “tentative” depth information.

In the present embodiment, the following processing is performed to modify the tentative depth information of the flat part. Accordingly, it is not necessary perform repeat operation and so on for to improving the accuracy of the matching, thereby suppressing the increase of the circuit volume and/or processing time of the stereo-matching module 1.

The block determiner 2 performs flat block determination which determines whether each block in the left eye is flat or non-flat (Step S2). For example, the block determiner 2 determines the block to be a flat block when variance of the luminance or color in the block is larger than a predetermined threshold.

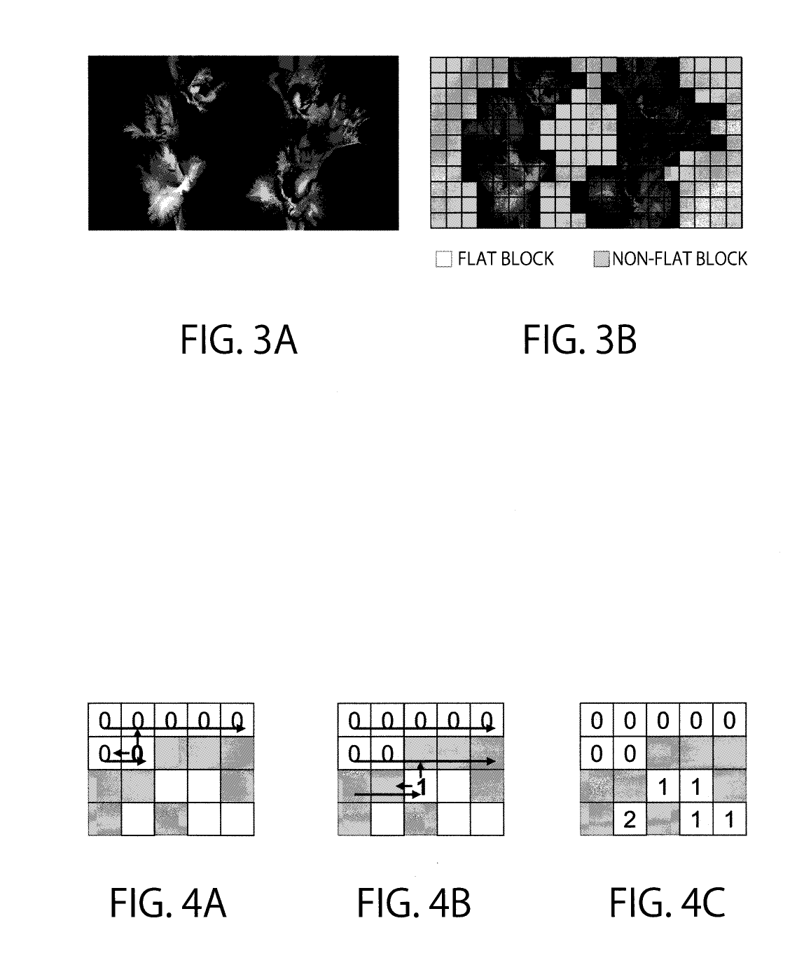

FIGS. 3A and 3B are diagrams showing an example of the flat block determination. As a result of processing the flat block determination on the image for left eye shown in FIG. 3A, blocks corresponding to a background of the image are determined to be flat blocks and blocks corresponding to the objects are determined to be non-flat blocks, as shown in FIG. 3B.

Referring back to FIG. 2, after the flat block determination, the flat area generator 3 performs, on the flat block, labeling processing for adding the same label to flat blocks which have continuity (Step S3).

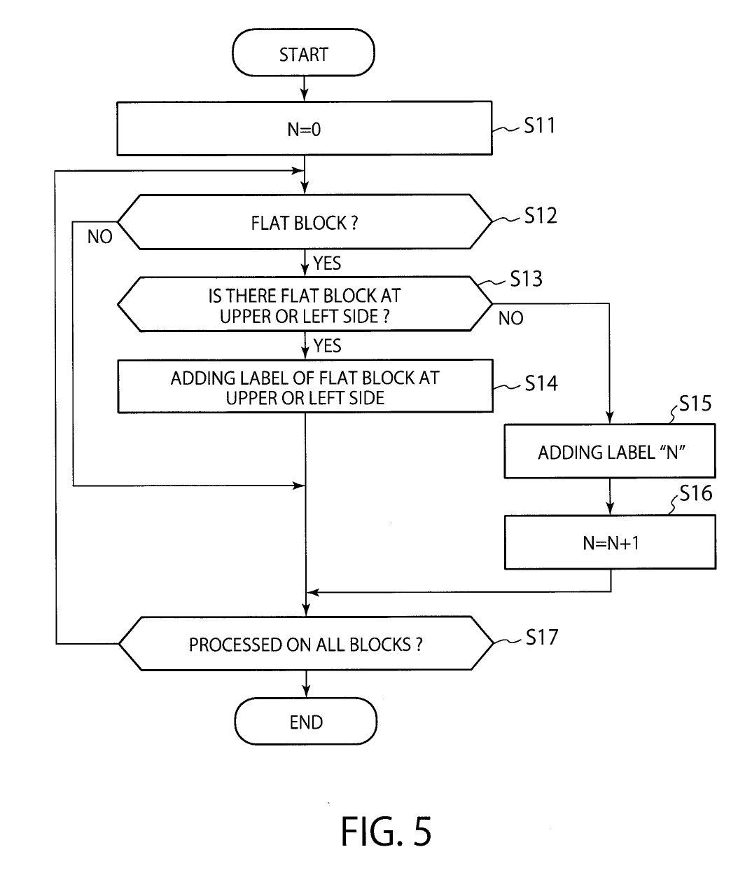

FIGS. 4A to 4C are diagrams showing an example of the labeling processing, which explains Step S3 of FIG. 2. Furthermore, FIG. 5 is a flowchart showing procedures of the labeling processing. FIGS. 4A to 4C and FIG. 5 show an example where the flat area generator 3 performs, on each of the flat blocks, the labeling processing in a raster scan order.

Firstly, the flat area generator 3 sets the number “N” of the label to be “0” (Step S11). Then, when the processing-target block is a flat block (Step S12—YES), the flat area generator 3 adds a label according to whether or not there is a flat block at upper-side or left-side, which will be explained below.

When there is a flat block at upper-side or left-side of the labeling-target flat block (Step S13—YES), one label has already been added to this flat block. Then, the flat area generator 3 adds a label identical to the label which has been added to the flat block to the labeling-target flat block (Step S14, FIG. 4A). Note that, if the label added to the block at upper-side is different from that added to the block at left-side, the flat area generator 3 adds the label having a smaller value.

On the other hand, when there is not a flat block at upper-side and left-side (Step S13—NO), the flat area generator 3 adds the label “N” to the labeling-target flat block (Step S15, FIG. 4B), and increments the number “N” of the label (Step S16).

The flat area generator 3 performs the above processing on all of the blocks in the image for left eye (Step S17). Accordingly, an identical label is added to flat blocks continuing in a horizontal direction or a vertical direction, as shown in FIG. 4C. The area composed of flat blocks to which the identical label is added is named as a flat area. In FIG. 4C, three flat areas, composed of flat blocks to which the labels “0” to “2” are added respectively, are generated. Hereinafter, the flat area composed of flat blocks to which the label “k” is added is named as flat area “k”.

Note that, depending on an arrangement of the flat block, different labels may be added to continuing flat blocks. Therefore, after the processing in a raster scan order, correspondence processing may be performed so that an identical label is added to continuing flat block using a reference table of the label.

Furthermore, an example has been described where flat block at only upper-side and left-side are referred, the flat block at upper-left-side and/or upper-right side may be referred. In this case, an identical label is added to flat blocks continuing, not only in the horizontal direction and the vertical direction, but also in a diagonal direction.

Referring back to FIG. 2, after the labeling processing, the flat area generator 3 performs elimination processing for eliminating a flat area, the number of the flat blocks in the flat area being smaller than a predetermined threshold, to assume the flat area as not a flat area (Step S4). This is because the flat area having a few flat blocks may be due to incorrect flat block determination or may be just a noise.

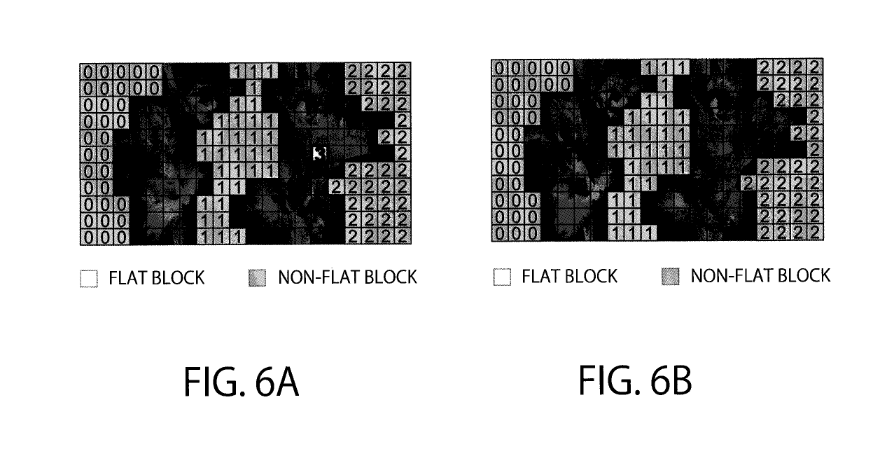

FIGS. 6A and 6B are diagrams showing an example of the elimination processing. In FIG. 6A, four flat areas, that is, a flat area “0” to a flat area “3” are generated. Each of the flat area “0” to flat area “2” includes a certain degree of flat blocks. On the other hand, the flat area “3” includes only one flat block. Therefore, the flat area generator 3 performs the elimination processing where the flat area “3” is assumed as not a flat area. As a result, three flat areas, that is, a flat area “0” to a flat area “2” are generated as shown in FIG. 6B.

Referring back to FIG. 2, after the elimination processing, the flat area generator 3 performs the combining processing for combining a plurality of non-continuous flat areas having similar features (Step S5). The feature is, for example, an average of the luminance or color in the flat area.

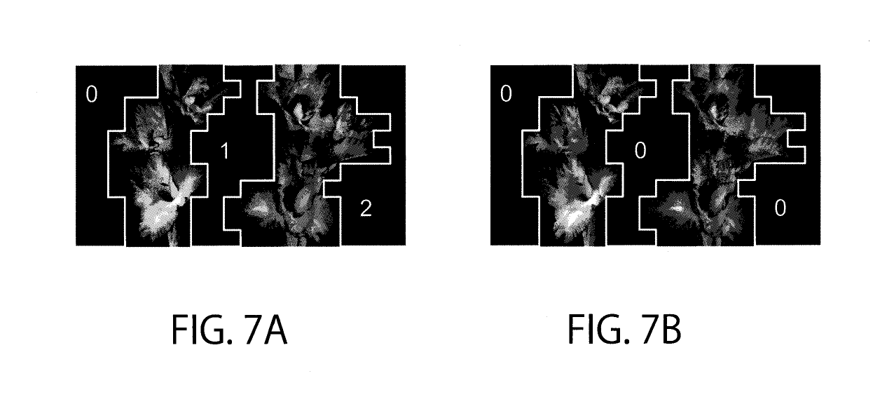

FIGS. 7A and 7B are diagrams showing an example of the combining processing. In FIG. 7A, as a result of the elimination processing, three flat areas “0” to “2” are generated. Here, the flat areas “0” to “2” are almost black, and thus, they have a similar feature. Therefore, as shown in FIG. 7B, the flat area generator 3 combines these flat areas “0” to “2” to set the flat area “0”. The image shown in FIGS. 7A and 7B, it is recognized that there are objects whose background is black space.

Accordingly, comparing to processing the flat areas “0” to “2” independently, more accurate depth information can be generated by combining them.

Note that, if similar flat areas are combined in first, the effect of the elimination processing may decrease because isolated flat areas having a few blocks are combined. Therefore, it is preferable that the combining processing (Step S5 of FIG. 2) is performed after the elimination processing (Step S4). However, these orders may be changed. Furthermore, the flat area generator 3 has the label used in Steps S3 to S5 as a map associated with each block in the image for left eye, for example. In the map, the value of the label is written to the flat block, and the particular value, which cannot be the value of the label, is written to the non-flat block.

Then, after the flat area is generated as the above, the depth information generator 4 generates the depth information added to all of the flat blocks in each of the flat areas in common (Step S6). In order to generate the depth information, it may be possible to use the tentative depth information of the flat block in the flat area and/or the tentative depth information of the non-flat block around the flat block in the flat area, for example. Hereinafter, some specific examples will be explained.

As a simple manner, the depth information generator 4 may set an average of the tentative depth information of the flat blocks in each of the flat areas as the depth information.

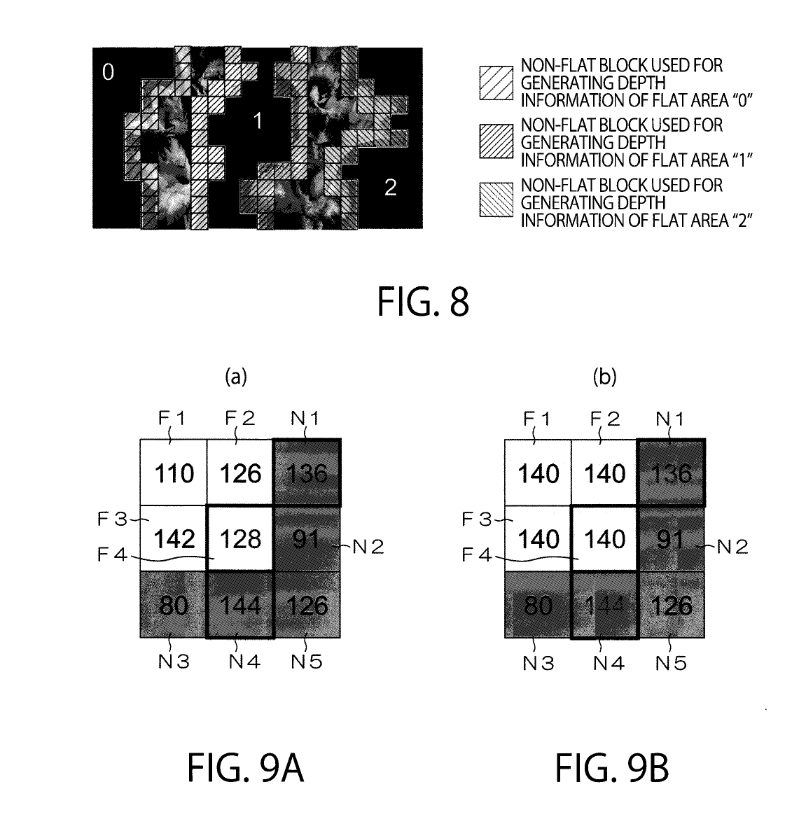

As another manner, as shown in FIG. 8, the depth information generator 4 may set the average of the tentative depth information of the non-flat blocks adjacent to the flat block in the flat area as the depth information. As described above, since the tentative depth information of the flat block is not always accurate, it is possible to improve the accuracy of the depth information by not using the tentative information of the flat blocks.

As another manner, as shown in FIGS. 9A and 9B, the depth information generator 4 may set the average of the tentative depth information of the non-flat blocks to be displayed at a further side compared to the flat blocks among the non-flat blocks adjacent to the flat blocks in the flat area, as the depth information.

Hereinafter, more specific explanation will be described with reference to FIGS. 9A and 9B. In FIG. 9A, only nine blocks are drawn for simplification, and four blocks F1 to F4 at upper-left side are the flat blocks, and the other blocks N1 to N5 are non-flat blocks. Furthermore, each of numerals in the block shows the tentative depth information added by the stereo-matching module 1. As the numeral is larger, the block should be displayed at further side.

Among non-flat blocks N1 and N2 adjacent to (including diagonal direction) the flat block F2, it is the non-flat block N1 that should be displayed at further side compared to the flat block F2, and the depth information of the non-flat block N1 is “136”. Among non-flat blocks N3 and N4 adjacent to the flat block F3, it is the non-flat block N4 that should be displayed at further side compared to the flat block F3, and the depth information of the non-flat block N4 is “144”. Among non-flat blocks N1 to N5 adjacent to the flat block F4, it is the non-flat blocks N1 and N4 that should be displayed at further side compared to the flat block F4, and the depth information of the non-flat blocks N1 and N4 are “136” and “144”, respectively.

Therefore, as shown in FIG. 9B, the average of them, which is (136+144+136+144)/4=140, is set as the depth information of the flat blocks F1 to F4 in the flat area.

Generally, it is considered that the flat area is a background and that the flat area is a part of foreground. Accordingly, it is likely that the flat area is displayed at the same depth as the non-flat area adjacent to the flat area or displayed at further side comparing to the non-flat area. Therefore, according to the manner shown in FIGS. 9A and 9B, it is possible to generate more natural and accurate depth information.

Note that, each of the above manners to generate the depth information is only an example, and various manners can be feasible to generate the depth information.

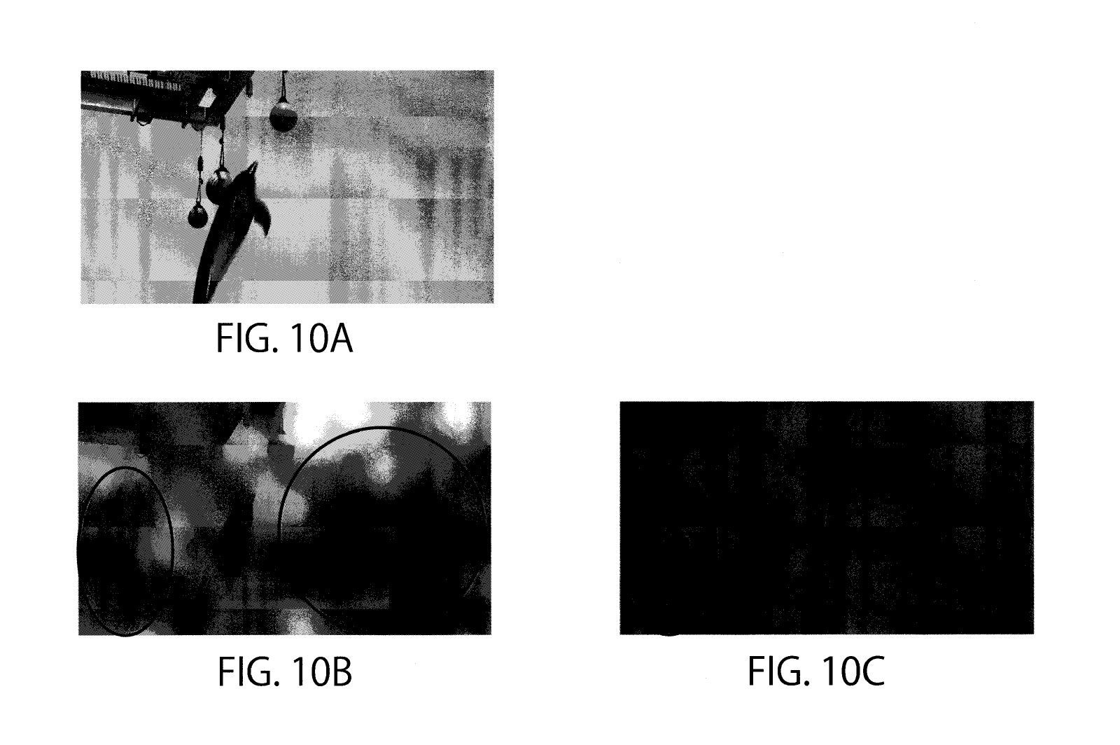

FIGS. 10A to 10C are diagrams showing the generated depth information schematically. FIG. 10A shows the image for left eye. FIG. 10B shows the tentative depth information added by the stereo-matching module 1. In FIG. 10B, as shown in areas enclosed by the continuous line, the depth information varies in the flat area. Therefore, if generating the parallax images using the tentative depth information to be displayed, the depth of each of the blocks differs from each other even in a flat area, due to which, concavity and convexity may be seen. On the other hand, FIG. 10C shows the depth information added by the depth information generator 4. In FIG. 10C, depth information in the flat area is almost uniform. Therefore, the flat area can be displayed flatly.

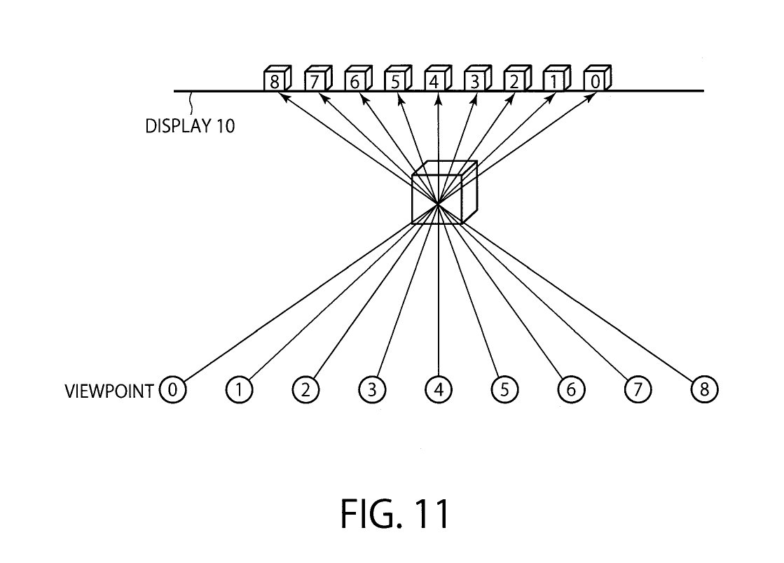

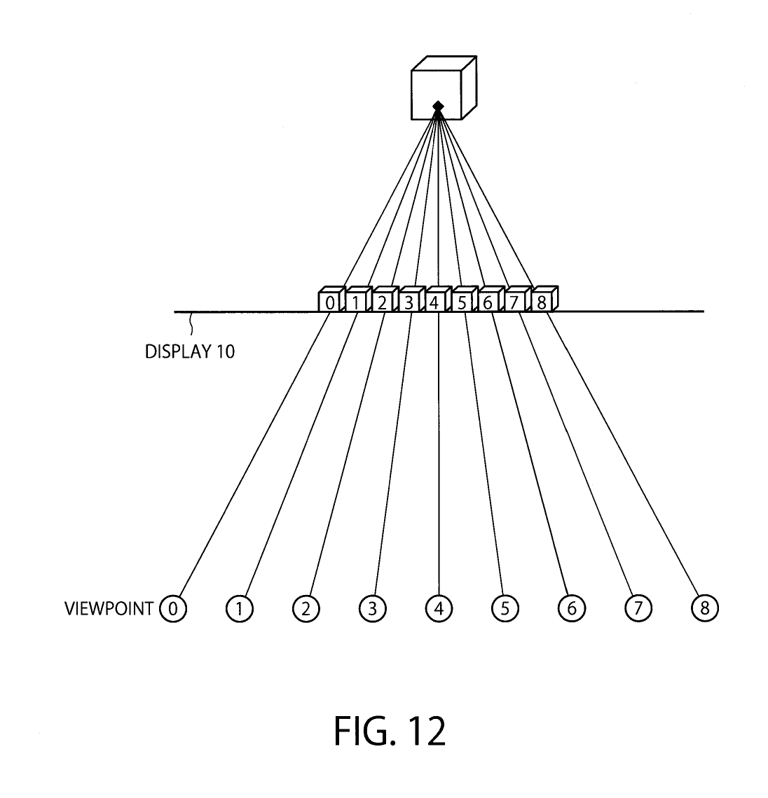

Referring back to FIG. 2, after the depth information is generated, the parallax image generator 5 generates nine parallax images from the image for left eye (Step S7). For example, as shown in FIG. 11, in a case of a parallax image viewed from left direction, the block which should be displayed nearer side from the display 10 is seen shifted to the right side. As the viewpoint locates at left side, the block is seen more shifted to the right side. Therefore, based on the depth information, the parallax image generator 5 shifts the block in the image for left eye, which should be displayed nearer side, to the right side. On the other hand, as shown in FIG. 12, in a case of a parallax image viewed from left direction, the block which should be displayed further side from the display 10 is seen shifted to the left side. As the viewpoint locates at left side, the block is seen more shifted to the left side considerably. Therefore, based on the depth information, the parallax image generator 5 shifts the block in the image for left eye, which should be displayed further side, to the left side.

Then, the part where the shifted block has been originally located is interpolated using the surrounding pixels. When generating the parallax image, the depth information generated by the depth information generator 4 is used for each block in the flat area, whereas the tentative depth information added by the stereo-matching module 1 is used for the other blocks.

Then, the generated nine parallax images are stereoscopically displayed on the display 10 (Step S8).

As stated above, in the present embodiment, identical depth information is added to continuing flat blocks. Therefore, accurate depth information can be generated even on the flat block, on which stereo-matching processing is difficult.

Note that, in the above embodiment, an example has been shown where the depth information is a depth value indicative of how far each block should be seen at near-side or far-side from the display 10. On the other hand, the depth information may be a parallax indicative of how a block in the image for right eye is shifted with regard to the corresponding block in the image for left eye.

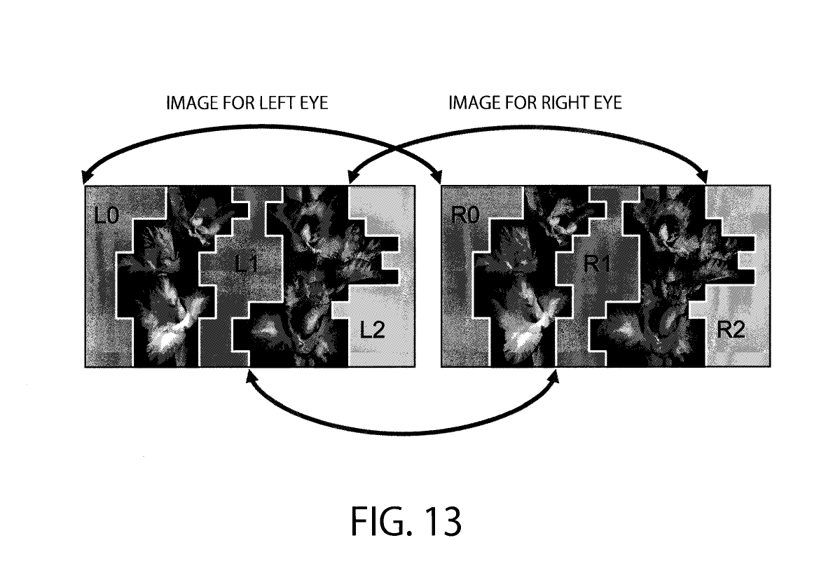

Furthermore, in the above embodiment, an example has been shown where processing of Step S2 and the later of FIG. 2 is performed on only the image for left eye. On the other hand, the parallax may be used as the depth information, and the above processing may be performed both on the images for left eye and right eye. As a result, as shown in FIG. 13, flat areas are generated both in the images for left eye and right eye. Then, the depth information generator 4 searches the flat area in the image for left eye (for example, flat area L0) and the flat area corresponding thereto in the image for right image (for example, flat area R0). This search can be performed based on a gravity of the flat area and/or the number of the flat blocks in the flat area, for example.

Then, the shift between the gravity of the image for left eye and that of the image for right eye is added to the flat block in the flat area in common as the parallax. When the search process is successful, more accurate depth information (parallax) can be obtained.

Note that, the image processing device includes at least a part of FIG. 1. For example, the stereo-matching module 1 can be omitted, and an input image, to which the tentative depth information is added in advance, is inputted to the block determiner 2.

At least a part of the image processing device explained in the above embodiments can be formed of hardware or software. When the image processing device is partially formed of the software, it is possible to store a program implementing at least a partial function of the image processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image processing device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device comprising:
a block determiner configured to determine whether each block in an input image is a flat block or a non-flat block;
a flat area generator configured to generate a flat area comprising at least one flat block based on continuity of the flat block; and
a depth information generator configured to generate depth information added to each flat block in the flat area.

2. The device of claim 1, wherein tentative depth information is added into each block in the input image in advance,
the depth information generator is configured to generate the depth information based on at least one of:
the tentative depth information of the flat block in the flat area; and
the tentative depth information of the non-flat block around the flat block in the flat area.

3. The device of claim 1, wherein tentative depth information is added into each block in the input image in advance,
the depth information generator is configured to set, as the depth information, an average of the tentative depth information of the non-flat block adjacent to the flat block in the flat area.

4. The device of claim 1, wherein tentative depth information is added into each block in the input image in advance,
the depth information generator is configured to set, as the depth information, an average of the tentative depth information of the non-flat block to be displayed at a further side compared to the flat block among the non-flat block adjacent to the flat block in the flat area.

5. The device of claim 2 further comprising a stereo-matching module configured to perform stereo-matching processing on a first image and a second image, the first image comprising a first viewpoint, the second image comprising a second viewpoint different from the first viewpoint, and configured to add the tentative depth information to each block in the first image,
wherein the flat block determiner is configured to perform processing on the first image as the input image.

6. The device of claim 1, wherein the flat area generator is configured to generate the flat area by performing labeling processing on the flat block.

7. The device of claim 1 further comprising:
a parallax image generator configured to generate a plurality of parallax images from the input image using the depth information of the flat area added by the depth information generator; and
a display to display the plurality of parallax images.

8. An image processing method comprising:
determining whether each block in an input image is a flat block or a non-flat block;
generating a flat area comprising at least one flat block based on continuity of the flat block; and
generating depth information added to each flat block in the flat area.

9. A non-transitory computer readable recording medium for recording an image processing program to cause a computer to execute:
determining whether each block in an input image is a flat block or a non-flat block;
generating a flat area comprising at least one flat block based on continuity of the flat block; and
generating depth information added to each flat block in the flat area.
